(19) United States
(12) Patent Application Publication
(10) Pub. No.: US 2009/0098411 A1
(43) Pub. Date: Apr. 16, 2009

(54) METHOD OF MANUFACTURING FERRITE POWDER, FERRITE POWDER, AND MAGNETIC RECORDING MEDIA

(75) Inventor: Yoshiaki Nakagawa, Tokyo (JP)

Correspondence Address: OLIFF & BERRIDGE, PLC, P.O. BOX 320850, ALEXANDRIA, VA, 22320-4850, US

(73) Assignee: TDK CORPORATION, Tokyo (JP)

(21) Appl. No.: 12/237,866

(22) Filed: Sep. 25, 2008

(30) Foreign Application Priority Data
Oct. 12, 2007 (JP) 2007-266251

(51) Int. Cl. G11B 5/00; B22F 9/00; C22C 38/00

(52) U.S. Cl. 428/800; 75/331; 420/8

(57) ABSTRACT

A method of manufacturing ferrite powder, by which a precursor obtained by an in-solution reaction method is heated at a temperature increase rate of 20° C./min or higher until arriving at a final temperature between 750 and 1200° C., the holding time at the final temperature being from 0 to 60 sec, and cooling from the final temperature to 300° C. being performed at a rate of 50° C./min or higher, to produce ferrite powder.

### BACKGROUND OF THE INVENTION

1. Field of the Invention

This invention relates to a method of manufacturing ferrite powder suitable for use in magnetic recording media, and in particular relates to a method of manufacturing ferrite powder with fine particles.

2. Related Background Art

In the past, ferrite powder has been synthesized by mixing oxides, hydroxides, carbonates, and various other compounds serving as starting materials in a prescribed composition, and performing heat treatment in an air atmosphere or in a gas atmosphere at atmospheric pressure, to cause reactions between the starting materials. The heat treatment conditions in this process have included heating at a rate of from 3 to 10° C./min, maintaining a temperature of 1200 to 1350° C. for approximately 1 to 3 hours, then cooling at a rate of 3 to 10° C./min.

In general, it has been necessary to perform heating to 1200 to 1350° C. when driving ferrite synthesis reactions. However, in the above-described heat treatment methods, the time of exposure to high temperatures is long, between 1 and 3 hours, so that as heat is further applied to portions which have completed the ferrite synthesis reaction, in addition to the reaction, grain growth also occurs. Precursors obtained by in-solution reaction methods, of which coprecipitation methods and organic salt methods are representative, have primary particles of size 100 nm or less, or are even finer, with sizes of 50 nm or less. However, even when using such fine-particle precursors, the primary particles of the ferrite powder obtained exceeds 100 nm. As a result, declines in the magnetic properties and dispersibility of the ferrite powder obtained are observed.

Japanese Patent Laid-open No. 2001-284112 discloses a manufacturing method in which, in order to obtain fine particles, rapid heating (24° C./min or higher) and rapid cooling (60° C./min or higher) are performed. An object of Japanese Patent Laid-open No. 2001-284112 is to manufacture magnetic powder used in bonded magnets. In this manufacturing methods, a precursor obtained by mixing various compounds is heated to 1500 to 1650K (1227 to 1377° C.), to cause a ferrite synthesis reaction. The minimum value of the particle diameters of the ferrite magnet powder obtained is 0.7 μm. However, it is preferable that particle diameters are smaller still for use as ferrite powder for magnetic recording media, such as data tape used in high-density recording, for example. Specifically, it is preferable that the particle diameters of primary particles of the ferrite powder are on average 100 nm or less.

### SUMMARY OF THE INVENTION

This invention was devised based on such technical problems, and has as an object the provision of a method of manufacturing fine ferrite powder suitable for use in magnetic recording media. More preferably, an object of the invention is to provide a method of manufacturing ferrite powder, the primary particles of which have an average particle diameter of 100 nm or less.

In inducing the ferrite synthesis reaction, heating to high temperatures is necessary; but if thermal energy exceeding the amount necessary for the ferrite synthesis reaction is applied, the energy causes sintering of particles, and grain growth occurs. Hence fine ferrite powder is fabricated by shortening to the extent possible the time of exposure to high temperatures, and, after the ferrite synthesis reaction, by cooling before the sintering reaction and grain growth occur.

At this time, when the size of the starting material (precursor) used in the reaction is large, the particles obtained are also large. For this reason, a fine precursor synthesized by an in-solution reaction method is used. A precursor obtained from an in-solution reaction method is fine, and components are uniform, so that the ferrite synthesis reaction can be realized at temperatures of 1200° C. or less, which are the standard heating temperatures used in the prior art.

Based on the above, a ferrite powder manufacturing method of this invention is characterized in that a precursor obtained by an in-solution reaction method is heated at a temperature increase rate of 20° C./min or higher until arriving at a final temperature between 750 and 1200° C., the holding time at the final temperature is from 0 to 60 sec, and cooling from the final temperature to 300° C. is performed at a rate of 50° C./min or higher. By means of this manufacturing method, ferrite powder with primary particles of average particle diameter 100 nm or less can be produced.

In a ferrite powder manufacturing method of this invention, it is preferable that the temperature increase rate is 50° C./min or higher. By setting the temperature increase rate to this range, ferrite powder having an average particle diameter of 50 nm or less can easily be obtained.

Further, when ferrite powder obtained by this invention is used in magnetic recording media, it is preferable that the ferrite powder comprise an element A (where A is at least one of Sr, Ba, Ca, and Pb) and Fe, and that the ferrite powder comprise W-type ferrite, for which, in the composition formula AZnₐ₍₁₋ₓ₎NiₐₓFe_{b}O₂₇, 0≦x≦1.0, 1.3≦a≦1.8, and 14≦b≦17 are satisfied.

By means of this invention, the ferrite synthesis reaction can be driven in a short length of time, while suppressing grain growth through rapid cooling. By this means, the average particle diameter of the ferrite powder obtained can be made 100 nm or less. And by using ferrite powder with an average particle diameter of 100 nm or less, the frequency characteristics of magnetic recording media can be improved, and recording densities can be raised.

### BRIEF DESCRIPTION OF THE DRAWINGS

FIG. 1 is a graph showing measurement results for particle sizes of primary particles in ferrite powder, when, in Example 1 and Comparison Example 1, the rate of temperature increase and final temperature were varied;

FIG. 2 is a graph showing measurement results for the saturation magnetization (Ms) of ferrite powder, when, in Example 1 and Comparison Example 1, the rate of temperature increase and final temperature were varied;

FIG. 3 is a graph showing measurement results for the coercivity (Hc) of ferrite powder, when, in Example 1 and Comparison Example 1, the rate of temperature increase and final temperature were varied;

FIG. 4 is a graph showing measurement results for particle sizes of primary particles in ferrite powder, when, in Example 2 and Comparison Example 2, the rate of temperature decrease was varied;

FIG. 5 is a graph showing measurement results for the saturation magnetization (Ms) and coercivity (Hc) of ferrite powder, when, in Example 2 and Comparison Example 2, the rate of temperature decrease was varied;

FIG. 6 is a graph showing measurement results for particle size of ferrite powder, when, in Example 3 and Comparison Example 3, the holding time was varied;

FIG. 7 is a graph showing measurement results for the saturation magnetization (Ms) and coercivity (Hc) of ferrite powder, when, in Example 3 and Comparison Example 3, the holding time was varied;

FIG. 8 is a graph showing measurement results for the sizes of primary particles in ferrite powder, when, in Example 4, the Ni substitution amount was varied;

FIG. 9 is a graph showing measurement results for the saturation magnetization (Ms) and coercivity (Hc) of ferrite powder, when, in Example 4, the Ni substitution amount was varied;

FIG. 10 is a graph showing measurement results for particle sizes of primary particles in ferrite powder, when, in Example 5 and Comparison Example 4, the rate of temperature increase and final temperature were varied;

FIG. 11 is a graph showing measurement results for the saturation magnetization (Ms) of ferrite powder, when, in Example 5 and Comparison Example 4, the rate of temperature increase and final temperature were varied;

FIG. 12 is a graph showing measurement results for the coercivity (Hc) of ferrite powder, when, in Example 5 and Comparison Example 4, the rate of temperature increase and final temperature were varied;

FIG. 13 is a graph showing measurement results for particle sizes of primary particles in ferrite powder, when, in Example 6 and Comparison Example 5, the rate of temperature increase and final temperature were varied;

FIG. 14 is a graph showing measurement results for the saturation magnetization (Ms) of ferrite powder, when, in Example 6 and Comparison Example 5, the rate of temperature increase and final temperature were varied; and,

FIG. 15 is a graph showing measurement results for the coercivity (Hc) of ferrite powder, when, in Example 6 and Comparison Example 5, the rate of temperature increase and final temperature were varied.

### DESCRIPTION OF THE PREFERRED EMBODIMENTS

Below, the invention is explained in detail based on aspects.

<Precursor>

This invention employs a ferrite precursor (hereafter simply called “precursor”) obtained by an in-solution reaction method.

As explained above, in-solution reaction methods include organic salt methods and coprecipitation methods.

The starting raw materials of the in-solution reaction method comprise a metal compound containing metal forming the ferrite, and another compound added together with this metal compound. This metal compound can be used in common with an organic salt method and with a coprecipitation method.

The metal compound containing metal forming the ferrite comprises an iron compound and another metal compound. As the iron compound, for example, iron nitrate ((Fe(NO₃)₃), iron sulfate (Fe₂(SO₄)₃), iron chloride (FeCl₃), or another water-soluble iron salt having trivalent iron can be used.

Further, the other metal compound is selected appropriately according to the desired ferrite composition. For example, when synthesizing an M-type (magnetoplumbite-type) ferrite powder, as the other metal compound, strontium nitrate (Sr(NO₃)₂), barium nitrate (Ba(NO₃)₂), or another water-soluble metal salt can be used. As the other metal compound, a metal salt containing a rare earth metal element, and a metal salt containing Co or Zn, can also be used as necessary.

The organic salt method can use, as the other compound, citric acid, oxalic acid, or another organic acid having the ability to form a complex with metal ions. Among these, citric acid is appropriate. The ferrite precursor obtained by the organic salt method is subjected to heat treatment of the metal forming hexagonal ferrite and the organic salt to decompose the organic component and decarbonizing, to obtain powder.

The coprecipitation method can use, as the other compound, an alkaline compound as a precipitant. As alkaline compounds, sodium hydroxide (NaOH), potassium hydroxide (KOH), and other alkali hydroxides, as well as ammonia (NH₃), can be used. Of these, sodium hydroxide and ammonia are appropriate. In the process of precipitation, sodium chloride (NaCl), ammonium chloride (NH₄Cl), and other sodium salts and ammonium salts are produced. The ferrite precursor obtained by a coprecipitation method comprises an oxide containing metal forming the ferrite and a hydroxide.

In an in-solution reaction method, a plurality of metal compounds containing metal forming the ferrite are dissolved in water and mixed, to prepare an aqueous solution. Then, another compound is added and mixed, to prepare the precursor.

It is preferable that the average particle diameter of primary particles comprised by a precursor obtained by an in-solution reaction method is 100 nm or less. This is in order to ensure that the average particle diameter of the primary particles of the ferrite powder obtained by heat treatment is 100 nm or less. It is preferable that the average particle diameter of primary particles is 50 nm or less, and still more preferable that the average particle diameter is 30 nm or less. No limitations in particular are placed on the lower-limit value, but values of 1 nm or greater are practical. This invention can drive a ferrite synthesis reaction while suppressing grain growth of such a fine-particle precursor. The precursor can also be granulated and provided for heat treatment.

“Particle diameter” means the largest diameter in the hexagonal base plane of primary particles of hexagonal-structure ferrite powder; “average particle diameter” means the calculated average thereof

<Heat Treatment>

The precursor obtained by an in-solution reaction method is subjected to heat treatment in order to cause a ferrite synthesis reaction. By means of this heat treatment, the ferrite synthesis reaction occurs instantaneously, and through rapid cooling, grain growth of the ferrite particles produced can be suppressed.

As explained above, in the prior art, heat treatment to induce the ferrite synthesis reaction was performed by a method in which the temperature was raised at a rate of temperature increase of 3 to 10° C./min to a final temperature, and then, after holding at the final temperature for 1 to 3 hours, cooling at a rate of temperature decrease of 3 to 10° C./min. However, in this method, grain growth occurs in the midst of the ferrite synthesis reaction treatment, so that even when using the precursor obtained by an in-solution reaction method, it is difficult to obtain fine ferrite powder. Ferrite powder obtained using the above-described temperature increase rates and temperature decrease rates normally has coarse particles of size 10 μm or greater.

In general, in order to drive a ferrite synthesis reaction, the total amount of heat energy imparted to the powder must be held within a fixed range. Hence when hastening the rate of temperature increase, the final temperature must be made high. Conversely, when slowing the rate of temperature increase, the final temperature must be lowered. When the rate of temperature increase is too fast for the final temperature, or when the final temperature is too low for the rate of temperature increase, unreacted residue and similar is observed. Conversely, when the rate of temperature increase is slow for the final temperature, or when the final temperature is too high for the rate of temperature increase, coarse particles are observed.

Details are given in descriptions of embodiments below, but in order to obtain ferrite powder with an average particle diameter of 100 nm or less, a temperature increase rate of at least 20° C./min or higher is required. Considering the characteristics of magnetic recording media, it is preferable that the average particle diameter of the primary particles of the ferrite powder obtained is 50 nm or less; to this end, the temperature increase rate of 50° C./min or higher is used. The temperature increase rate is in practice limited to 1000° C./sec by the performance of firing furnaces, and so it is preferable that the upper limit of the temperature increase rate is 1000° C./sec.

In order that the average particle diameter of primary particles of the ferrite powder obtained may be 100 nm or less, when the rate of temperature increase is 20° C./min, the final temperature must be in the range 800 to 900° C. Similarly, when the rate of temperature increase is 50° C./min or higher, the final temperature must be 900° C. or higher.

If the temperature increase rate is 50° C./min or higher, then theoretically no upper limit is imposed on the final temperature. However, if the temperature exceeds 1200° C., energy efficiency is worsened, and so it is preferable that the final temperature is 1200° C. or lower, and still more preferable that the final temperature is 900 to 1100° C.

When the temperature decrease rate is 20° C. or lower, coarse particles are observed.

When the temperature decrease rate is 50° C./min, although some coarse particles appear, fine particles are also observed. However, there are not many very fine particles with particle diameters of 20 nm or less.

When the temperature decrease rate is 100° C./min, there is a dramatic decline in the occurrence of coarse particles, and moreover many fine particles with particle diameters of 20 nm or less are seen.

From the above, the rate of temperature decrease in this invention is set to 50° C./min or higher. It is preferable that the rate of temperature decrease is 100° C./min or higher, and still more preferable that the rate is 1000° C./min or higher. However, because the practical limit to the temperature decrease rate which can actually be attained is approximately 1000° C./sec, it is preferable that the temperature decrease rate in this invention is 1000° C./sec.

In this invention, the rate of temperature decrease is maintained from the final temperature to 300° C. This is because at 300° C. or less, there is no concern of the occurrence of grain growth.

In a ferrite synthesis reaction of the prior art, the holding time at the final temperature is from I to 3 hours. However, in a ferrite powder manufacturing method of this invention, as a rule the final temperature is not held (for example, the holding time is zero). This is in order not to impart necessary heat to the ferrite powder after completion of the ferrite synthesis reaction. However, in this invention, a holding time of up to 60 seconds can be permitted.

The average particle diameters of primary particles of ferrite powder obtained by this invention is 100 nm or less. When used for high-density magnetic recording media, if the average particle diameter is 100 nm or greater, the shorter wavelengths accompanying high recording densities cannot be accommodated, and the surface roughness of the magnetic recording media is increased, so that spacing losses are greater. It is preferable that the average particle diameter of primary particles of the ferrite powder is 50 nm or less, and still more preferable that the average particle diameter is 30 nm or less.

Ferrite to which this invention is applied includes W-type ferrite and magnetoplumbite (M) type ferrite, which are hexagonal ferrite types. When manufacturing W-type ferrite powder, it is preferable that each particle comprises a single W phase. However, the inclusion of an M phase, spinel phase, and other phases with the W phase is permissible, within the range in which there is no effect on magnetic characteristics. When manufacturing M-type ferrite powder, it is preferable that each particle comprises a single M phase, but inclusion of other phases is permitted, as described above.

When considering use in magnetic recording media, the upper limit to Hc enabling erasure and writing with current magnetic heads is 4000 Oe, and a value of 3000 Oe or less is preferable. When considering storage stability, a coercivity (Hc) of 1000 Oe or higher is preferable, and a value of 1200 Oe or higher is still more preferable. It is preferable that the saturation magnetization (Ms) is 50 emu/g or higher. W-type ferrite can have these characteristics. In this invention, among W-type ferrites, it is particularly preferable that an element A (where A is at least one of Sr, Ba, Ca, and Pb) and Fe be comprised, and that, for the composition formula AZnₐ₍₁₋ₓ₎NiₐₓFe_{b}O₂₇, that 0≦x≦1.0, 1.3≦a≦1.8, and 14≦b≦17 be satisfied.

An M-type ferrite with a coercive force (Hc) of approximately 6000 Oe is easily obtained. In this case, another element can be substituted for a constituent element of the ferrite to lower the coercivity (Hc) to 4000 Oe or less.

Ferrite powder of this invention can be applied to magnetic tape, magnetic cards, magnetic disks, and other well-known magnetic recording media.

For example, on magnetic tape, a lower non-magnetic layer and a magnetic layer are formed, in this order, on one side of base film. Thus magnetic tape is configured so as to enable recording and playback of various recording data by a recording/playback device.

Also, on the other side of the base film, a back coat layer is formed to improve tape traveling performance and to prevent base film scratching (abrasion) and charge buildup on the magnetic tape. The structure of magnetic tape is not limited to this structure, and any well-known structure can be used.

<Magnetic Layer>

A magnetic layer is obtained by application of a magnetic coating. A magnetic coating has magnetic powder and a binder dispersed in a solvent; a well-known dispersant, lubricant, abrasive, hardening agent, antistatic agent, and similar may be added as necessary. As the magnetic powder, ferrite powder obtained by this invention can be used.

As the binder, a vinyl chloride copolymer, polyurethane resin, acrylic resin, polyester resin, or another heat-curing resin, as well as a radiation-curing resin, or another well-known material can be used.

<Lower Nonmagnetic Layer>

As the underlayer material, a material comprising a nonmagnetic powder and a binder can be used. A dispersant, abrasive, lubricant, and similar can be added as necessary.

As the nonmagnetic powder, carbon black, α-iron oxide, titanium oxide, calcium carbonate, α-alumina, or another inorganic powder, or a mixture of these, can be used.

As the binder, dispersant, abrasive, or lubricant of the underlayer, dispersants, abrasives, and lubricants similar to those used in the magnetic coating can be employed.

<Back Coat Layer>

A well-known structure and composition can be used for the back coat layer. For example, a back coat layer containing carbon black or a nonmagnetic inorganic powder other than carbon black and a binder can be used.

<Method of Manufacture>

In this invention, no limitations in particular are placed on the method of manufacture of magnetic recording media, and a well-known magnetic recording media manufacturing method can be used. For example, coatings can be fabricated by mixing, kneading, dispersing, and diluting materials, and the various layers can be formed by using well-known application methods to apply coatings onto a supporting member to form the lower nonmagnetic layer, magnetic layer, and back coat layer. Alignment, drying, and calendaring treatment can be performed as necessary. After application, curing treatment is performed, and by cutting into the desired shape, or incorporating into a cartridge, magnetic recording media is manufactured.

### EXAMPLE

Below, examples and comparison examples are used to give a more specific explanation of the content of the invention; however, the invention is not limited to the following examples.

### Example 1

Iron nitrate ((Fe(NO₃)₃.9H₂O), strontium nitrate (Sr(NO₃)₂), zinc nitrate (Zn(NO₃)₂.6H₂O), and nickel nitrate (Ni(NO₃)₂.6H₂O) were weighed out so as to yield a chemical composition with Fe:Sr:Zn:Ni=15.0:1.0:0.75:0.75 (Sr_{1.0}Zn_{0.75}Ni_{0.75}Fe_{15.0}Oₓ). These starting materials were dissolved in ion exchange water such that the Fe concentration was 0.2 mol/L.

Next, this solution was mixed with a citric acid solution with a concentration of 10 mol %, such that the citric acid concentration was equivalent to five times the total molar concentration of metal ions. This mixture of solutions was heated at 80° C. for three hours, and then heated at 120° C. until gelling occurred. The gel obtained was dessicated in a nitrogen gas flow at 120° C., and then a furnace in which the oxygen partial pressure could be controlled was used to perform decomposition of the organic materials at 300 to 600° C. Thereafter crushing was performed to fabricate the precursor. The average particle diameter of the primary particles of the precursor was 20 nm.

An infrared image furnace (MILA-3000 manufactured by ULVAC-RIKO Inc.) was used to perform heat treatment (ferrite synthesis reaction) of the precursor, and W-type ferrite powder was fabricated. This heat treatment was performed with the various final temperatures and rates of temperature increase indicated below. In this example, heating was halted immediately after reaching the final temperature, and cooling was begun. That is, the hold time in this example was zero. Cooling was performed at 1000° C./min until approximately 300° C., and thereafter cooling was at a rate of 60° C./min until room temperature.

The final temperatures and temperature increase rates in heat treatment were as follows. Heat treatment was performed at each of the final temperatures and at each of the temperature increase rates, to fabricate a plurality of ferrite powders under different heat treatment conditions.
Final temperatures: 800° C., 900° C., 1000° C., 1100° C., 1200° C.
Temperature increase rates: 20° C./min, 50° C./min, 100° C./min, 200° C./min

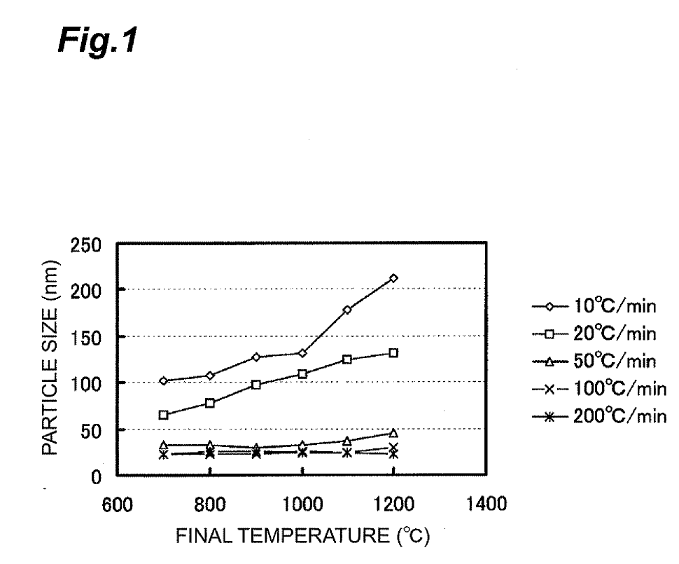

The primary particle average particle diameter, saturation magnetization (Ms), and coercivity (Hc) were measured for each of the ferrite powders thus obtained. The average particle diameter of primary particles of ferrite powder (the particle size in FIG. 1) was determined by measuring particle diameters for 100 particles using TEM (Transmission Electron Microscope), and taking the average value to be the particle size. The average particle diameter of primary particles of precursor was similarly measured. The saturation magnetization (Is) and coercivity (Hc) were measured using a VSM (Vibrating Sample Magnetometer).

### Comparison Example 1

Except for modifying the final temperature and rate of temperature increase during heat treatment to i) and ii) below, ferrite powder was fabricated by a procedure similar to that of Example 1, and the average particle diameter of primary particles, saturation magnetization (Ms), and coercivity (Hc) were measured.

i) Final temperature: 700° C., rate of temperature increase: 10° C./min, 20° C./min, 50° C./min, 100° C./min, 200° C./min

ii) Rate of temperature increase: 10° C./min, final temperature: 800° C., 900° C., 1000° C., 1100° C., 1200° C.

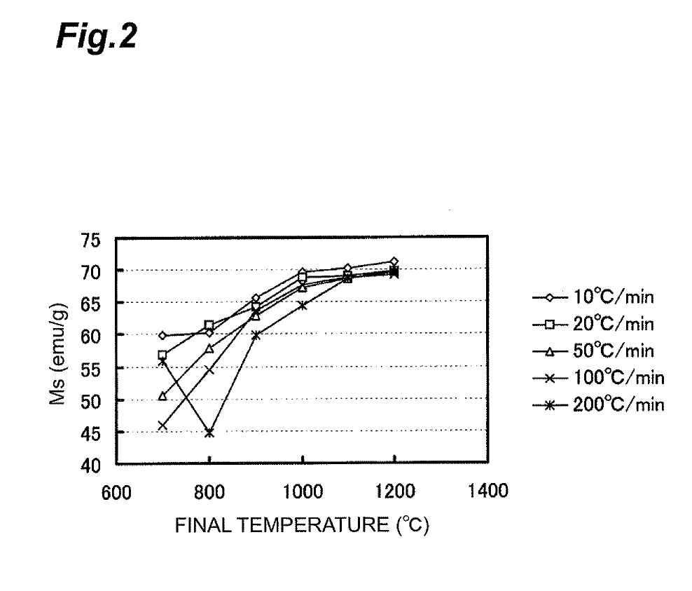

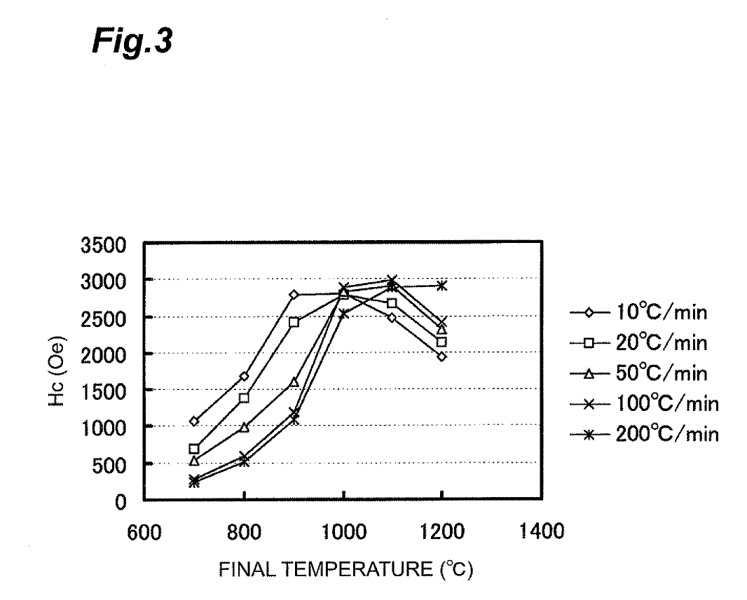

Measurement results for the ferrite powders of Example 1 and Comparison Example 1 appear in FIG. 1 to FIG. 3.

With respect to particle sizes, as the rate of temperature increase was raised, particle sizes grew smaller. This was because when the rate of temperature increase was fast, the time until the final temperature was reached was shortened, so that grain growth could be suppressed. Conversely, when the final temperature was high, and moreover the rate of temperature increase was low, grain growth was prominent.

When the rate of temperature increase is 20° C./min, by selecting the final temperature the particle size can be kept to 100 nm or less, but it is difficult to obtain a particle size of 50 nm or less. On the other hand, if the rate of temperature increase is made 50° C./min or higher, ferrite powder can be obtained having particle sizes with the average particle diameter of primary particles of 50 nm or less, regardless of the final temperature. Considering that the average particle diameter of primary particles of the precursor is approximately 20 nm, it can be said that at a temperature increase rate of 50° C./min or higher, almost no grain growth occurs.

Where the saturation magnetization (Ms) is concerned, powder manufactured in Example 1 generally has a saturation magnetization (Ms) of 50 emu/g or higher, and can be used in magnetic recording media. In order to obtain a higher saturation magnetization (Ms), the final temperature should be made higher, and the rate of temperature increase should be lower. By this means, the amount of heat energy applied is increased, and crystallinity can be improved.

With respect to the coercivity (Hc) also, comments similar to those for the saturation magnetization (Ms) can generally be made; but there exists a peak in the relationship between coercivity (Hc) and final temperature. That is, the value of the coercivity (Hc) is high for final temperatures in the range 900 to 1100° C.

When using ferrite powder in magnetic recording media, a coercivity (Hc) of 1000 to 4000 Oe is required, and a value of 1200 to 3000 Oe is preferable. In order to satisfy this requirement, the rate of temperature increase and the final temperature must be adjusted. For example, when the rate of temperature increase is 20° C./min, the final temperature must be made 800° C. or higher, and when the rate of temperature increase is 100° C./min, the final temperature must be made 900° C. or higher.

### Example 2

Except for setting the rate of temperature increase to 100° C./min and the final temperature to 1000° C., and setting the rate of temperature decrease from the final temperature to 300° C. as indicated below, a procedure similar to that of Example 1 was used to manufacture ferrite powder.

Rate of temperature decrease: 50° C./min, 100° C./min, 200° C./min, 1000° C./min

Similarly to Example 1, the primary particle average particle diameter (particle size), saturation magnetization (Ms), and coercivity (Hc) of the ferrite powder thus manufactured were measured.

### Comparison Example 2

Other than modifying the rate of temperature decrease from the final temperature to 300° C. as indicated below, a procedure similar to that of Example 2 was used to manufacture ferrite powder.

Rate of temperature decrease: 10° C./min, 20° C./min

Similarly to Example 1, the primary particle average particle diameter (particle size), saturation magnetization (Ms), and coercivity (Hc) of each of the ferrite powders thus manufactured were measured.

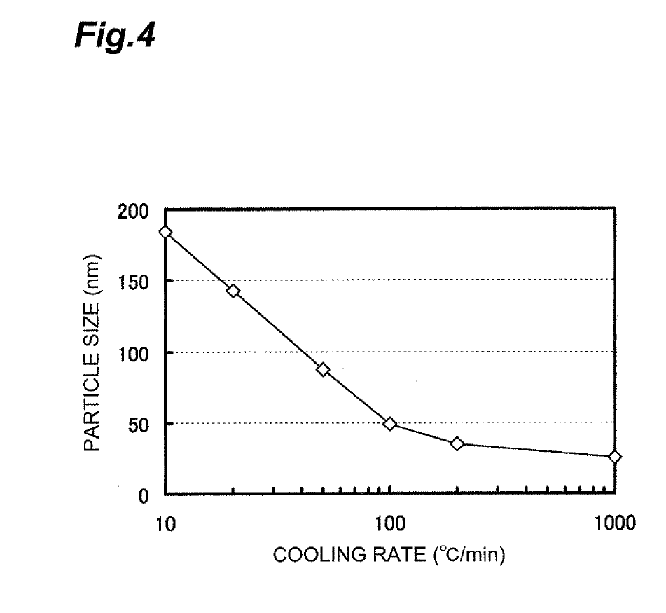

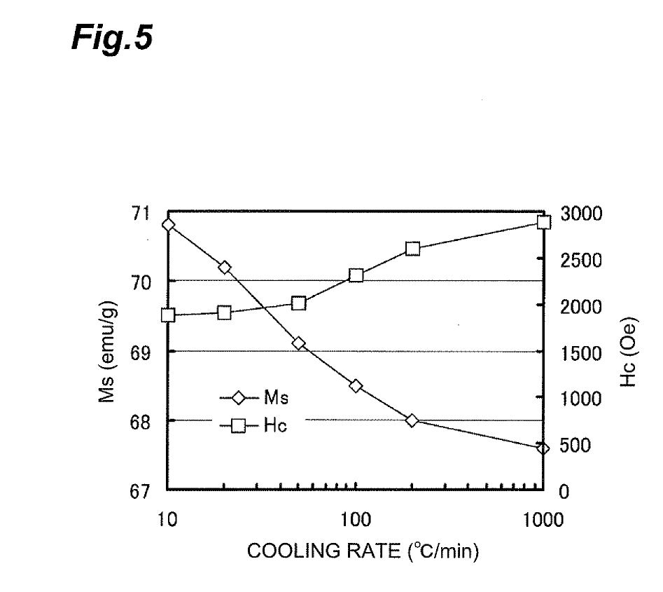

Results for the ferrite powders of Example 2 and Comparison Example 2 appear in FIG. 4 and FIG. 5. In terms of particle size, the faster the rate of temperature decrease, the smaller are the particle sizes, so that by hastening the rate of temperature decrease, grain growth in the cooling process is suppressed. In order to reduce particle sizes to 100 nm or less, it is preferable that the rate of temperature decrease is 50° C./min or higher, and in order to further reduce particle sizes to 50 nm or less, it is preferable that the rate of temperature decrease is 1 000° C./min or higher.

The saturation magnetization (Ms) and coercivity (Hc) met requirements for magnetic recording media under all sets of conditions.

### Example 3

Except for setting the rate of temperature increase to 100° C./min and the final temperature to 1000° C., and setting the holding time at the final temperature as indicated below, a procedure similar to that of Example 1 was used to manufacture ferrite powder.

Holding time: 0 sec, 1 sec, 10 sec, 30 sec, 60 sec

Similarly to Example 1, the primary particle average particle diameter (particle size), saturation magnetization (Ms), and coercivity (Hc) of the ferrite powder thus manufactured were measured.

### Comparison Example 3

Other than modifying the holding time at the final temperature to 300 sec, a procedure similar to that of Example 1 was used to manufacture ferrite powder.

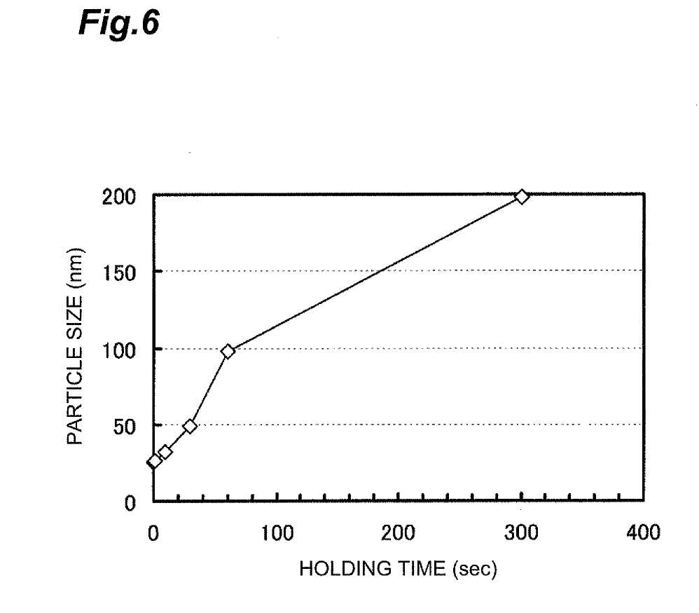

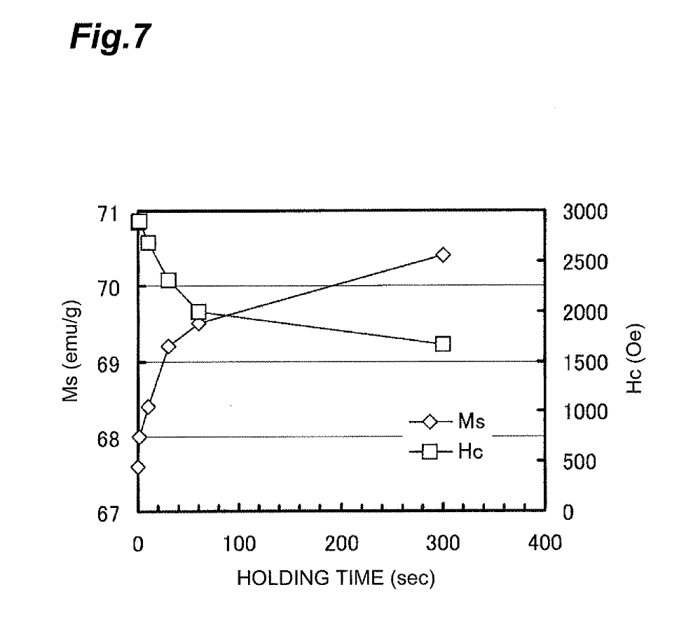

Measurement results for ferrite powders of Example 3 and Comparison Example 3 appear in FIG. 6 and FIG. 7. With respect to particle sizes, the longer the holding time, the larger particle sizes became. At a holding time of 60 sec, particle sizes could be made 100 nm or less, and at a holding time of 30 sec, particle sizes could be made 50 nm or less. In order to obtain finer ferrite powder, it is preferable that there is no holding at the final temperature.

The saturation magnetization (Ms) and coercivity (Hc) met requirements for magnetic recording media under all sets of conditions.

### Example 4

Except for setting the rate of temperature increase to 100° C./min and the final temperature to 1000° C., and using the composition formulas indicated below, a procedure similar to that of Example 1 was used to manufacture ferrite powder.

Composition formulas:

| | | |
|---|---|---|
| Sr_{1.0}Zn_{1.50}(Ni₀)Fe_{15.0}Oₓ | Ni substitution amount: | 0 at % |
| Sr_{1.0}Zn_{1.125}Ni_{0.375}Fe_{15.0}Oₓ | Ni substitution amount: | 25 at % |
| Sr_{1.0}Zn_{0.75}Ni_{0.75}Fe_{15.0}Oₓ | Ni substitution amount: | 50 at % |
| Sr_{1.0}Zn_{0.375}Ni_{1.125}Fe_{15.0}Oₓ | Ni substitution amount: | 75 at % |
| Sr_{1.0}(Zn₀)Ni_{1.125}Fe_{15.0}Oₓ | Ni substitution amount: | 100 at % |

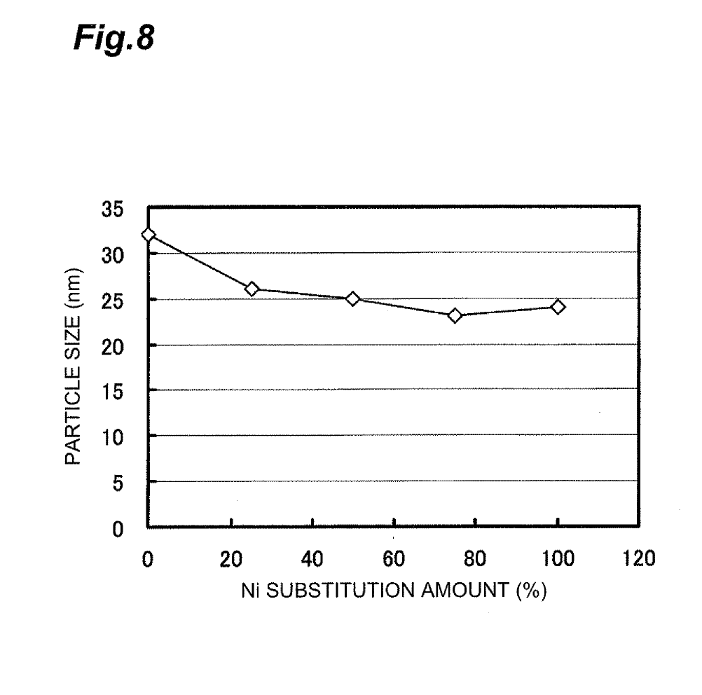

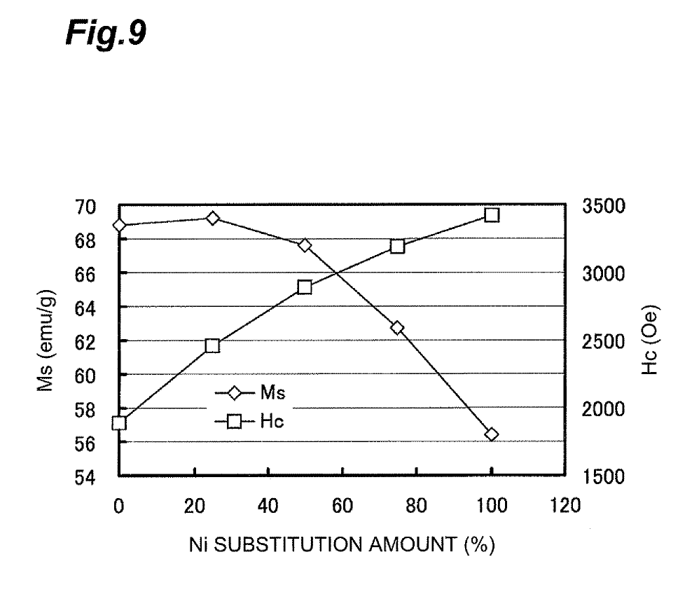

Similarly to Example 1, the primary particle average particle diameter (particle size), saturation magnetization (Ms), and coercivity (Hc) were measured for the ferrite powders obtained. Results appear in FIG. 8 and FIG. 9.

There was no significant change in particle size with the Ni substitution amount, but substitution of a portion of the Fe with Ni as well as Zn can reduce particle size.

Whereas the saturation magnetization (Ms) declined with increasing amount of Ni substitution, the coercivity (Hc) tended to rise as the amount of Ni substitution was increased. For Ni substitution amounts in the range 0 to 100 atomic percent, the characteristics required of magnetic recording media were satisfied; but in order to keep the coercivity (Hc) within the desired range, the Ni substitution amount should be 75 at % or lower.

### Example 5

Iron nitrate ((Fe(NO₃)₃.9H₂O), strontium nitrate (Sr(NO₃)₂), zinc nitrate (Zn(NO₃)₂.6H₂O), and nickel nitrate (Ni(NO₃)₂.6H₂O) were weighed out so as to yield a chemical composition with Fe:Sr:Zn:Ni=15.0:1.0:0.75:0.75 (Sr_{1.0}Zn_{0.75}Ni_{0.75}Fe_{15.0}Oₓ), and these starting materials were dissolved in ion exchange water such that the Fe concentration was 0.2 mol/L.

Next, this solution was mixed with a sodium hydroxide aqueous solution with concentration 3 mol % such that the pH was 13, and precipitate was prepared. The solution containing this precipitate was heated for two hours at 100° C., and after filtering and rinsing with water, the precipitate was separated. This precipitate was dried in air at 120° C., and crushed to obtain coprecipitate powder (precursor).

Thereafter, other than using final temperatures and rates of temperature increase as follows during heat treatment, a similar procedure to that of Example 1 was used to prepare powder.

Final temperature: 800° C., 900° C., 1000° C., 1100° C., 1200° C.

Rate of temperature increase: 20° C./min, 50° C./min, 100° C./min

Similarly to Example 1, the primary particle average particle diameter (particle size), saturation magnetization (Ms), and coercivity (Hc) were measured for each of the ferrite powders obtained.

### Comparison Example 4

Other than modifying the final temperature and the rate of temperature increase as indicated below, a procedure similar to that of Example 5 was used to manufacture ferrite powder, and the primary particle average particle diameter, saturation magnetization (Ms), and coercivity (Hc) were measured.

Rate of temperature increase: 10° C./min

Final temperature: 800° C., 900° C., 1000° C., 1100° C., 1200° C.

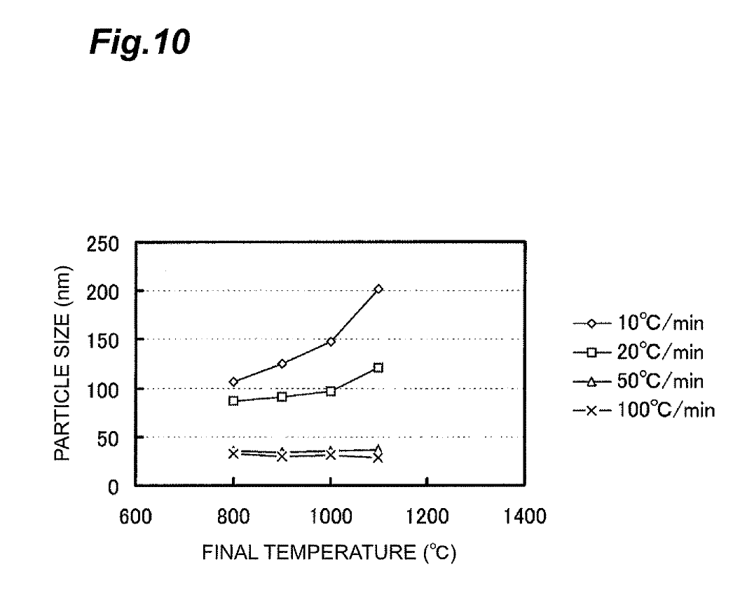

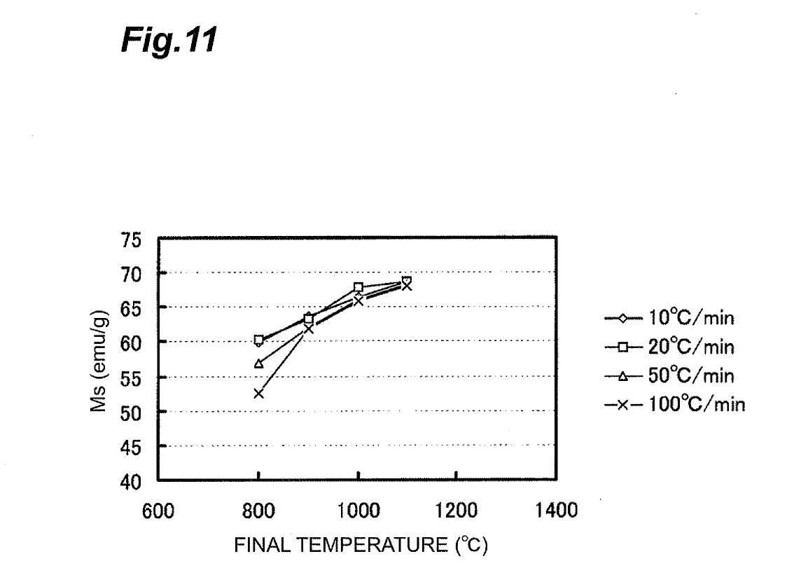

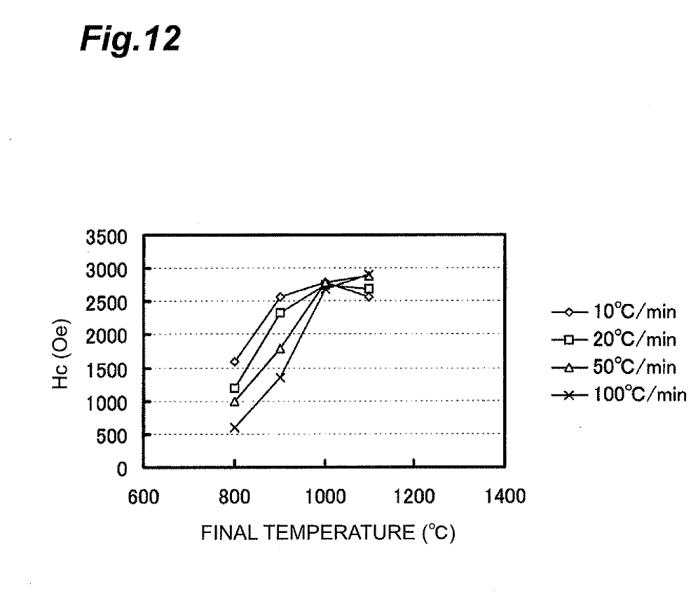

Measurement results for the ferrite powders of Example 5 and Comparison Example 4 appear in FIG. 10 to FIG. 12. Even when using a precursor obtained by a coprecipitation method, tendencies similar to those of cases when using the precursor obtained by an organic salt method (Example 1 and Comparison Example 1) were observed.

### Example 6

Iron nitrate ((Fe(NO₃)₃.9H₂O), strontium nitrate (Sr(NO₃)₂), lanthanum nitrate (La(NO₃)₃.6H₂O), and cobalt nitrate (Co(NO₃)₂.6H₂O) were weighed out so as to yield a chemical composition with Fe:Sr:La:Co=11.7:0.7:0.3:0.3 (La_{0.3}Sr_{0.7}Co_{0.3}Fe_{11.7}Oₓ); other than this, a procedure similar to Example 1 was used to prepare a precursor.

Other than using the final temperatures and rates of temperature increase indicated below in heat treatment of the precursor prepared in this way, a procedure similar to Example 1 was used to perform heat treatment and fabricate M-type ferrite powder.

Final temperature: 800° C., 900° C., 1000° C., 1100° C., 1200° C.

Rate of temperature increase: 50° C./min, 100° C./min, 200° C./min

Similarly to Example 1, the primary particle average particle diameter (particle size), saturation magnetization (Ms), and coercivity (Hc) of ferrite powders prepared in this way were measured.

### Comparison Example 5

Other than using the final temperatures and rate of temperature increase in heat treatment indicated below, a procedure similar to Example 6 was used to prepare M-type ferrite powders, and the primary particle average particle diameter, saturation magnetization (Ms), and coercivity (Hc) were measured.

Rate of temperature increase: 10° C./min

Final temperature: 800° C., 900° C., 1000° C., 1100° C., 1200° C.

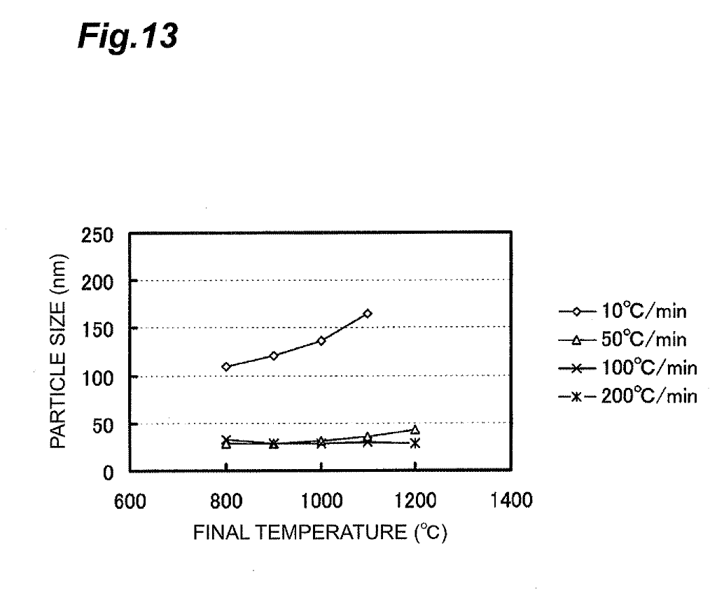

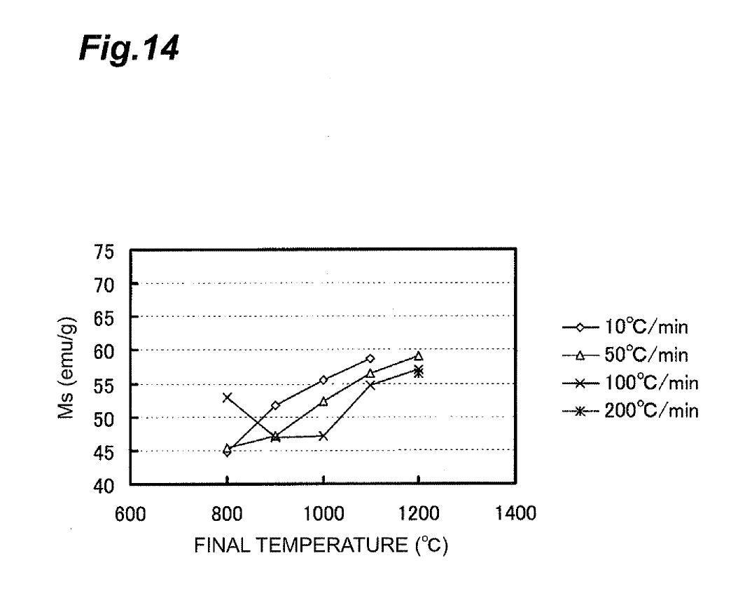

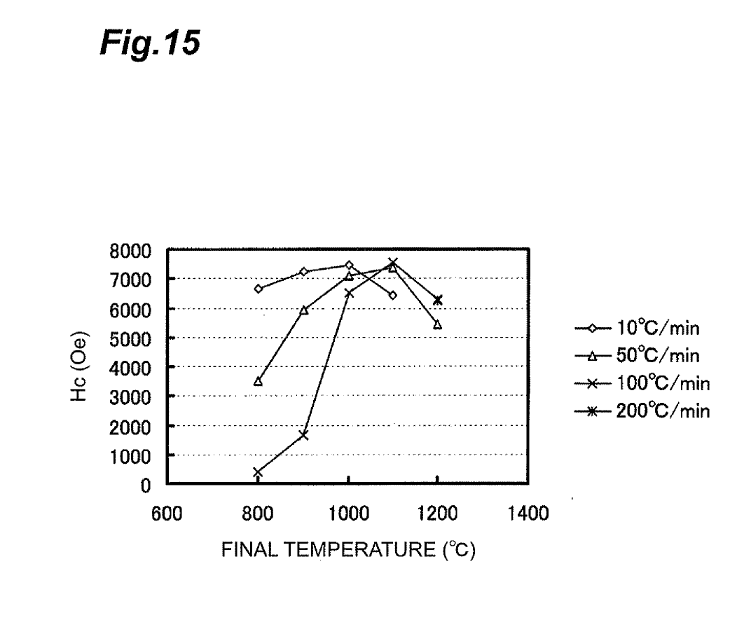

Results for the ferrite powders of Example 6 and Comparison Example 5 appear in FIG. 13 to FIG. 15. M-type ferrites showed tendencies similar to those of W-type ferrite powders Example 1 and Comparison Example 1).

### Example 7

<Preparation of Coating for Magnetic Layer>

100 parts by weight of the ferrite powder obtained in Example 1 (average particle diameter 32 nm, rate of temperature increase 50° C./min, final temperature 1000° C., holding time 0 sec), 10 parts by weight vinyl chloride (MR104 produced by Zeon Corp.), 10 parts by weight polyester urethane (UR8700 produced by Toyobo Co. Ltd.), 6 parts by weight α-Al₂O₃, 2 parts by weight phthalic acid, and a mixed solvent (methylethyl ketone (MEK)/toluene/cyclohexane=2/2/6 (weight ratio)) were added, the solid fraction was adjusted to 80 wt %, and kneading was performed for 2 hours. To the kneaded slurry was added a mixed solvent (MEK/toluene/cyclohexane=2/2/6 (weight ratio)), to obtain a slurry the solid fraction of which was 30 wt %. Then, in a horizontal pin mill packed with zirconia beads, dispersing processing of this slurry was performed. Thereafter, a mixed solvent (MEK/toluene/cyclohexane=2/2/6 (weight ratio)), 1 part by weight stearic acid, and 1 part by weight butyl stearate were added, to obtain a slurry the solid fraction of which was 10 wt %. 100 parts by weight of this slurry was added to 0.4 parts by weight isocyanate compound (Coronate L produced by Nippon Polyurethane Industry Co. Ltd.), to obtain a coating for a magnetic layer.

<Preparation of Lower Nonmagnetic Layer Coating>

85 parts by weight of acicular α-Fe₂O₃, 15 parts by weight carbon black, 15 parts by weight electron beam-cured vinyl chloride resin, 10 parts by weight electron beam-cured polyester polyurethane resin, 5 parts by weight α-Al₂O₃, 2 parts by weight o-phthalic acid, 10 parts by weight methylethyl ketone (MEK), 10 parts by weight toluene, and 10 parts by weight cyclohexane were placed in a pressurized kneader, and kneading was performed for 2 hours.

The kneaded slurry was added to a mixed solvent (MEK/toluene/cyclohexane=2/2/6 (weight ratio)), to obtain a slurry the solid fraction of which was 30 wt %. Then, in a horizontal pin mill packed with zirconia beads, dispersing processing of this slurry was performed for 8 hours. Thereafter, a mixed solvent (MEK/toluene/cyclohexane=2/2/6 (weight ratio)), 1 part by weight stearic acid, and 1 part by weight butyl stearate were added, to obtain a slurry the solid fraction of which was 10 wt %, for use as the lower nonmagnetic layer coating.

<Preparation of Back Coat Layer Coating>

50 parts by weight of nitrocellulose, 40 parts by weight polyester polyurethane resin, 85 parts by weight carbon black, 15 parts by weight BaSO₄, 5 parts by weight copper oleate, and 5 parts by weight copper phthalocyanine were added to a ball mill, and dispersing was performed for 24 hours. Then, a mixed solvent (MEK/toluene/cyclohexane=1/1/1 (weight ratio)) was added, to obtain a slurry the solid fraction of which was 10 wt %. Next, to 100 parts by weight of this slurry was added 1.1 parts by weight of an isocyanate compound, to obtain the back coat layer coating.

<Manufacture of Magnetic Tape>

On the surface of a polyethylene terephthalate film of thickness 6.1 μm, the above-described lower nonmagnetic layer coating was applied so as to have a thickness after drying of 1.0 μm. After drying, calendering was performed, and finally electron beam irradiation was performed to cure the film, forming the lower nonmagnetic layer.

Next, magnetic layer coating was applied onto the lower nonmagnetic layer such that the thickness after drying was 0.05 μm. Then, magnetic field alignment treatment was performed, followed by drying and calendering, to form the magnetic layer.

Next, the above-described back coat layer coating was applied to the rear surface of the polyethylene terephthalate film such that the thickness after drying was 0.6 μm. After drying, calendering was performed to form the back coat layer. In this way, the various layers were formed on the two surfaces to obtain unfinished magnetic tape. Thereafter, the unfinished magnetic tape was placed in an oven at 60° C. for 24 hours and heat-cured. Then the unfinished tape was cut to a width of ½ inch (12.65 mm), to obtain magnetic tape.

### Comparison Example 6

Other than using a rate of temperature increase of 5° C./min and a final temperature of 900° C. in heat treatment, with the holding time at the final temperature equal to 1 hour, a procedure similar to Example 1 was used to prepare ferrite powder. The average particle diameter of the ferrite powder thus prepared was 500 nm.

Other than using this ferrite powder, a procedure similar to Example 7 was used to manufacture magnetic recording media (magnetic tape).

<Evaluation of Electromagnetic Transducing Characteristics>

Using a drum tester and MIG head, signals were recorded onto the magnetic tapes of Example 7 and of Comparison Example 6 at a recording wavelength of 0.2 μm. Thereafter, a GMR head was used to reproduce the recorded signals. The ratio of the output voltage of single-wave signals to the noise voltage at a separation of 1 MHz was evaluated as the C/N of the reproduced signals. When the C/N of the magnetic tape of Comparison Example 6 was 0 dB, the C/N of the magnetic tape of Example 7 was 3 dB, exhibiting superior electromagnetic transducing characteristics.

What is claimed is:

1. A method of manufacturing ferrite powder, comprising: heating a precursor obtained by an in-solution reaction method at a rate of temperature increase of 20° C./min or higher until arriving at a final temperature between 750 and 1200° C.,
the holding time at said final temperature being from 0 to 60 sec, and
cooling from said final temperature to 3 00° C. being performed at a rate of temperature decrease of 50° C./min or higher.

2. The method of manufacturing ferrite powder according to claim 1, wherein said rate of temperature increase is 50° C./min or higher.

3. The method of manufacturing ferrite powder according to claim 1, wherein the average particle diameter of primary particles of said ferrite powder is 100 nm or less.

4. The method of manufacturing ferrite powder according to claim 1, wherein said ferrite powder comprises hexagonal ferrite.

5. A ferrite powder manufactured by the method of manufacture according to claim 1.

6. A magnetic recording medium using the ferrite powder manufactured by the method of manufacture according to claim 1.
